(19) United States
(12) Patent Application Publication
(10) Pub. No.: US 2021/0116949 A1
(43) Pub. Date: Apr. 22, 2021

(54) CELL PHONE HEATING DEVICE

(71) Applicant: Changing International Company Limited, Kowloon (HK)

(72) Inventor: Han-Che CHEN, Taipei City (TW)

(21) Appl. No.: 16/654,220

(22) Filed: Oct. 16, 2019

(51) Int. Cl. G05D 23/19; H04M 1/02; G05B 15/02

(52) U.S. Cl. CPC G05D 23/19; G05B 15/02; H04M 1/0262

(57) ABSTRACT

A cell phone heating device for heating a cell phone is provided, including: a main body; a heating element disposed in the main body for heating the cell phone; a temperature-control element disposed in the main body for detecting the temperature of the main body and providing a signal to control the heating element according to the temperature; and a power source disposed in the main body for providing current to the heating element and the temperature-control element.

### BACKGROUND OF THE DISCLOSURE

### Field of the Disclosure

The present disclosure relates to cell phone heating device, and especially it relates to a cell phone heating device that can be used in cold environments.

### Description of the Related Art

Cell phones have been indispensable tools for modern people. However, in a cold environment, low temperatures (such as less than 5° C.) may lower the reaction rate of the battery in the cell phone, which may result in the discharged current being too low to power the cell phone, causing the cell phone to be unusable. Although cell phone bags and cases with heating functions are commercially available, they are mostly used for heating the external environment (such as the user's hand), and heat insulating material would be provided on a surface that is in contact with the cell phone to prevent the cell phone from being heated. Moreover, some of them require power from the cell phone. As a result, they cannot adequately heat the cell phone in a cold environment.

### BRIEF SUMMARY OF THE DISCLOSURE

A cell phone heating device for heating a cell phone is provided, including: a main body; a heating element disposed in the main body for heating the cell phone; a temperature-control element disposed in the main body for detecting the temperature of the main body and providing a signal to control the heating element according to the temperature; and a power source disposed in the main body for providing current to the heating element and the temperature-control element.

In some embodiments, the main body includes a back plate, and the power source and the temperature-control element are disposed in the back plate.

In some embodiments, the main body further includes a cover plate, and the thickness of the back plate is greater than the thickness of the cover plate.

In some embodiments, the main body further includes two cover plates, and the thickness of the back plate is greater than the thickness of the cover plates.

In some embodiments, the main body includes a top layer and a bottom layer, and the top layer is in physical contact with the cell phone.

In some embodiments, the main body further includes a middle layer disposed between the top layer and the bottom layer, and the heating element is disposed in the middle layer.

In some embodiments, the material of the top layer includes a heat conductive material, and the material of the bottom layer includes heat insulating material.

In some embodiments, the heating element is a resistive heating element.

In some embodiments, a connecting hole is formed in the main body for connecting other elements.

In some embodiments, the cell phone heating device further includes a switch disposed in the main body for activating the heating element to generate heat for a specific amount of time.

A cell phone heating device for heating a cell phone is provided in another embodiment of the present disclosure, including: a main body including a back plate, wherein the back plate includes a top layer and a bottom layer, the top layer is in physical contact with the cell phone, the material of the top layer includes heat conductive material, and the material of the bottom layer includes heat insulating material; a heating element disposed in the main body for heating the cell phone; and a power source disposed in the main body for providing current to the heating element.

### BRIEF DESCRIPTION OF THE DRAWINGS

Aspects of the present disclosure are best understood from the following detailed description when read with the accompanying figures.

FIGS. 1A and 1B are schematic views of a cell phone heating device with a cellphone.

FIG. 1C is an explosive view of the cell phone heating device.

FIG. 1D is a schematic view of some elements of the cell phone heating device.

FIG. 1E is a cross-sectional view of the cell phone heating device.

FIG. 1F is an enlarged view of FIG. E.

FIG. 2 is a block diagram showing the functions of the cell phone heating device.

FIG. 3 is a flow chart of an operation method of the cell phone heating device in some embodiments of the present disclosure.

### DETAILED DESCRIPTION OF THE DISCLOSURE

The making and using of the embodiments of a cell phone heating device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the disclosure may be practiced are shown by way of illustration. In this regard, directional terminology, such as “top,” “bottom,” “left,” “right,” “front,” “back,” etc., is used with reference to the orientation of the figures being described. The components of the present disclosure can be positioned in a number of different orientations. As such, the directional terminology is used for the purposes of illustration and is in no way limiting.

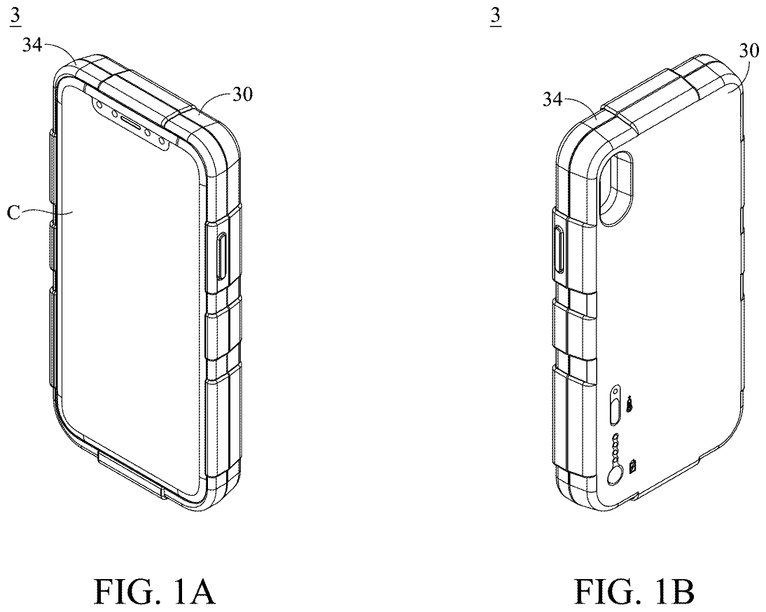

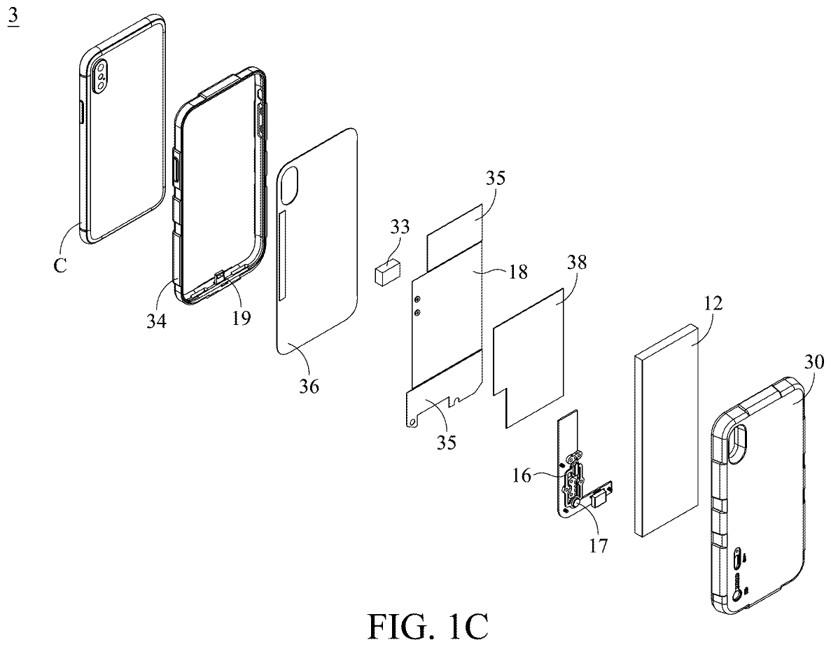

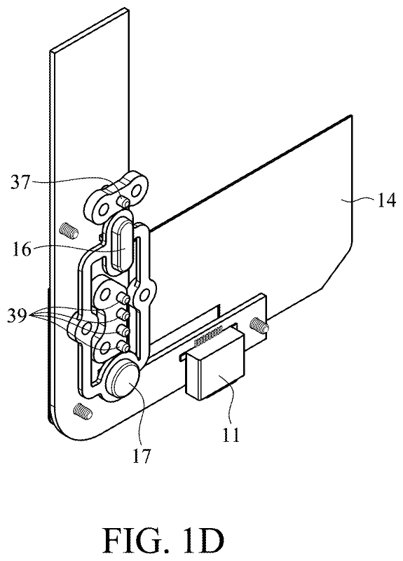

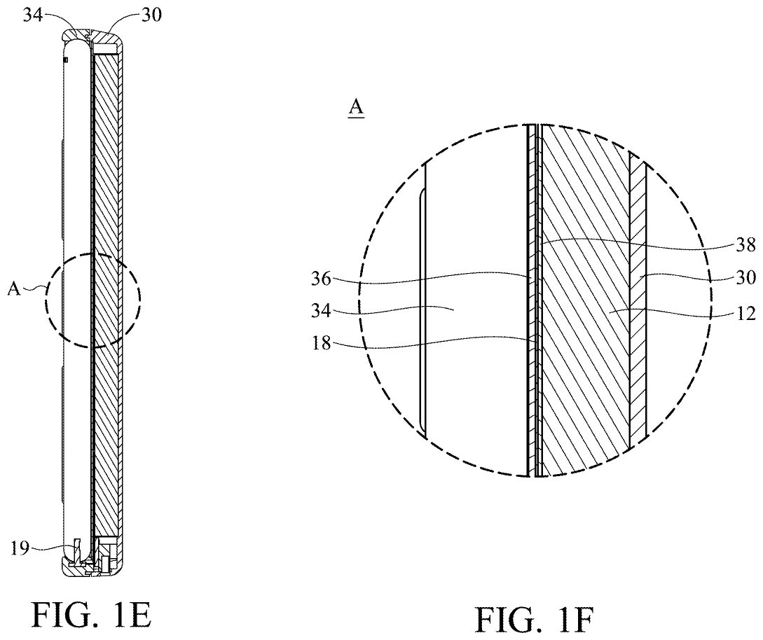

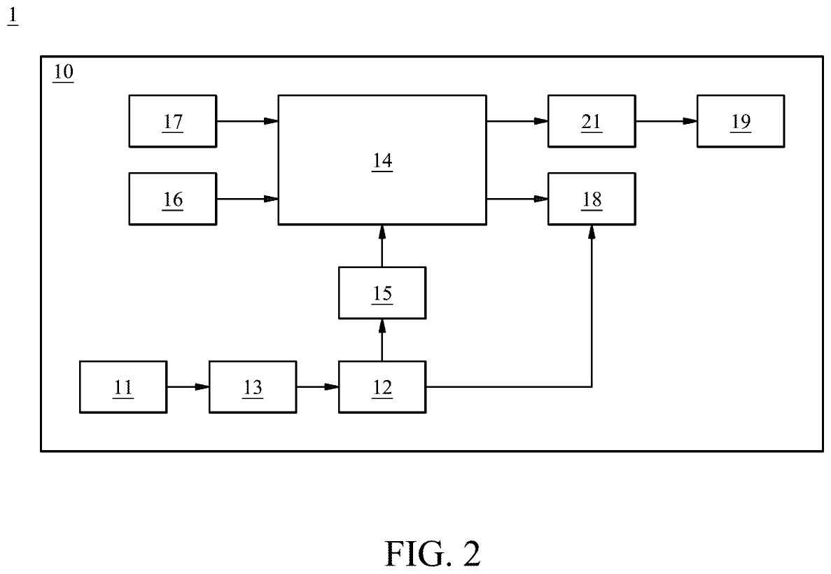

FIGS. 1A and 1B are schematic views of a cell phone heating device 3 with a cellphone C. and FIGS. 1C and 1D are an explosive view and a cross-sectional view of the cell phone heating device 3, respectively. FIG. 2 is a block diagram showing the functions of the cell phone heating device 3 in the embodiments of the present disclosure. In some embodiments, the cell phone heating device 3 may be a case covering some of the cellphone C and exposing the screen of the cellphone C.

The cell phone heating device 3 mainly includes a case 30, a frame 34, a charging port 11, a power source 12, a temperature-control element 14, a switch 16, a switch 17, a heating element 18 and a connecting hole 19. The charging port 11 may be electrically connected to the power source 12, and the power source 12 may be electrically connected to the temperature-control element 14, the switches 16 and 17, and the heating element 18.

The power source 12 may be an element for storing energy and providing current to the temperature-control element 14 and the heating element 18, such as a battery (e.g. a lithium battery). The power source 12 may discharge in a temperature range between about −40° C. to about 50° C., especially between a low temperature range of about −20° C. to about 0° C. (as required by commercial electronic products), or between a ultra-low temperature range of about −20° C. to about −40° C. (as required by military). In other words, the power source 12 is operable under −20° C. As a result, the cell phone heating device 3 may work properly when the temperature is lower than 0° C. or −20° C.

In some embodiments, the power source 12 may have a specific range of discharge voltage, such as between 4.2V to 3.0V to maintain the stability of the battery. If the discharge voltage is lower than 3.0V, a protecting process may be initiated to avoid the power source 12 from keeping discharge. In some embodiments, a voltage transform circuit 15 (FIG. 2) may be provided for the power source 12 to ensure the output voltage has a specific value (e.g. 5.0V). In some embodiments, the power source 12 may be charged through a charging port 11 and a charging circuit 13 (FIG. 2) electrically connected to the power source 12.

The temperature-control element 14 is used for detecting the temperature in the cell phone heating device 3. If the temperature of the cell phone heating device 3 is too low (such as lower than about IOT or −20° C.), the heating element 18 may be driven by the temperature-control element 14 to heat the cell phone heating device 3 to a specific temperature (such as a temperature between −2° C. to 15° C., or between 15° C. to 20° C.). As a result, the temperature of the cell phone may be kept within an operable range when the temperature of the external environment is too low, so the cell phone C may be prevented from becoming dysfunctional due to low temperature. Furthermore, after the temperature-control element 14 detects that the temperature of the cell phone heating device 3 has reached a specific temperature, the temperature-control element 14 would stop the heating element 18 from heating the to prevent unnecessarily wasting energy, so the available time of the cell phone heating device 3 may be extended.

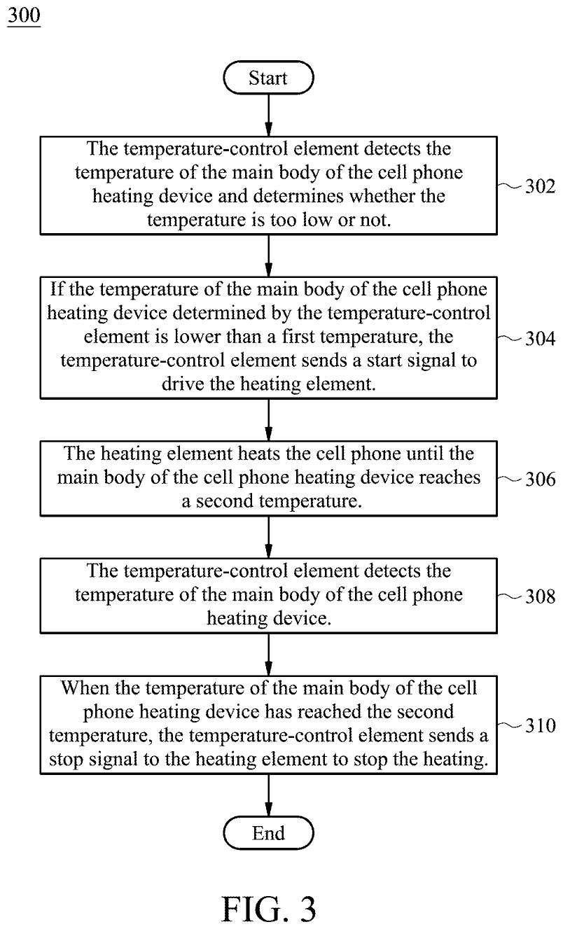

Besides providing current to the temperature-control element 14 and the heating element 18, the power source 12 may provide current to other external electronic devices (e.g. a cellphone) outside the cell phone heating device 3 through the connecting hole 19 (FIG. 3) and an output circuit 21 (FIG. 2) to act as a backup power source. When the power source 12 acts as a backup power source, the output current may between 1 A to 2 A.

When the temperature of the cell phone C is too low and causing the cell phone to be dysfunctional, the cell phone may be restored to its normal operating situation faster if the cell phone heating device 3 is simultaneously being used to heat the cell phone and to provide current to the cell phone being heated.

Besides using the temperature-control element 14 to detect the external temperature and then to drive the heating element 18, the heating element 18 may be manually driven by the switch 16 as well. For example, the heating element 18 may operate for a while (such as about 1 to 5 minutes) after pressing the switch 16. As a result, the problem wherein the cell phone will not operate due to low temperatures may be solved without relying on the temperature-control element 14 accordingly.

The case 30 and the frame 34 may be assembled with each other to form a main body for the cell phone heating device 3, and other elements may be disposed therein. In some embodiments, the case 30 and the frame 34 may be formed integrally. A plate 36 may be disposed between the heating element 18 and the cell phone C, and another plate 38 may be disposed between the heating element 18 and the power source 12 to avoid the heating element 18 directly contact with other electronic component. In some embodiments, the plate 38 may be made from heat insulating materials, such as mica, but the present disclosure is not limited thereto. Furthermore, spacers 33 and 35 may be provided adjacent to the heating element 18 and between the plates 36 and 38 to fill the gap and for bonding the elements. The spacers 33 and 35 may be formed from soft materials, such as foam, plastic (e.g. PVC) etc., and adhesive material (not shown) may be provided on the spacers 35. In some embodiments, the spacers 33 and 35 may be made from different materials (e.g. the spacer 33 may be formed from foam, and the spacers 35 may be formed from plastic (e.g. PVC)), and the present disclosure is not limited thereto. In some embodiments, the spacer 35 and the plate 36 may be made from an identical material. In some embodiments, the temperature-control element 16 and the heating element 18 does not overlap with each other when viewed in a normal direction of the plate 36.

FIG. 1D is an enlarged view of some elements of the cell phone heating device 3. The temperature-control element 14 may be disposed on a circuit board. In some embodiments, the cell phone heating device 3 may include a display element exposed from the case 30 to show the battery level and whether the heating element 18 is working or not. For example, the display element may include a plurality of illuminating units 39 (such as LEDs), and each of the illuminating unit 39 may indicate different information (such as four illuminating units 39 for indicating different power level and one illuminating unit 37 for indicating whether the heating element 18 is working or not, but the present disclosure is not limited thereto). In some embodiments, the illuminating units 39 for indicating different power level and the illuminating unit 37 for indicating whether the heating element 18 is working or not may have different colors, such as having white and red colors, respectively, but the present disclosure is not limited thereto.

In some embodiments, one illuminating unit 17 that indicates whether the heating element 18 is working or not may flash when the power source 12 is charging. All of the illuminating units 39 for indicating different power level may be lighted up if the power source 12 is fully charged, and one of the illuminating units 39 for indicating different power level may be lighted up when the power source 12 is providing power to the heating element 18 or other external electronic devices. In some embodiments, when the power level of the power source 12 is low (e.g. less than 15% of total energy), an illuminating unit 39 may flash to indicate the low battery level. If a user tries to turn on the cell phone heating device 3 when the power level of the power source 12 is low, the illuminating unit 39 may flash for several times (e.g. 10 times), and then the cell phone heating device 3 may be turned off. In some embodiments, if short circuit happens (e.g. during heating or charging), all of the illuminating units 39 may flash to indicate short circuit.

In some embodiments, after the switch 16 is pressed for a while (e.g. 1.5 s), the illuminating unit 17 illustrating whether the heating element 18 is working or not may be initiated, and the heating element 18 may start working. Afterwards, after the switch 16 is pressed again for a while (e.g. 1.5 s), the illuminating unit 17 and the heating element 18 may be turned off.

In some embodiments, the switch 17 may be used for controlling the cell phone heating device 3 to charge other external electronic devices (e.g. the cell phone C or other electronic devices). For example, the cell phone heating device 3 may start or stop charging other external electronic devices by pressing the switch 17 for a while (e.g. 1.5 s). In some embodiments, the switches 16 and 17 and the illuminating units 37 and 39 may be electrically connected with each other in parallel.

FIG. 1E is a cross-sectional view of the cell phone heating device 3, and FIG. 1F is an enlarged view of FIG. 1E. It should be noted that a plate may be disposed between the heating element 18 and the cell phone C, and another plate may be disposed between the heating element 18 and the power source 12 to avoid the heating element 18 directly contact with other electronic component. The plate-shaped heating element 18 can increase the (indirect) contact area with the cell phone C to enhance the heating performance.

FIG. 3 is a flow chart of an operation method of the cell phone heating devices in the embodiments of the aforementioned embodiments. In step 302, the temperature-control element detects the temperature of the main body of the cell phone heating device and determines whether the temperature is too low or not.

In step 304, if the temperature of the main body of the cell phone heating device determined by the temperature-control element is lower than a first temperature (e.g. less than 10° C.) in the step 302, the temperature-control element sends a start signal to drive the heating element to heat the cell phone.

In step 306, the heating element may be driven to heat the cell phone after receiving the start signal generated from the temperature-control element, until the cell phone heating device reaches a second temperature (e.g. 20° C.).

In step 308, the temperature-control element detects and determines whether the temperature of the main body of the cell phone heating device has reached the second temperature or not.

In step 310, when the temperature of the main body of the cell phone heating device has reached the second temperature, the temperature-control element sends a stop signal to the heating element to stop the heating.

In the aforementioned steps, current is provided by the power source (e.g. a battery) to the temperature-control element and the heating element, and the power source may be operated at a temperature as low as about −20° C. to allow the cell phone heating device to operate normally at low temperatures.

As a result, the cell phone heating device in the present disclosure may determine the current temperature and automatically heat the cell phone according to the temperature to ensure the cell phone may operate normally under a cold environment, rather than being affected by the low temperature environment and causing the battery of the cell phone cannot discharge normally. Furthermore, the cell phone heating device may automatically stop heating after the temperature reaches a desired temperature to avoid wasting energy.

In summary, a cell phone heating device that can be used in a cold environment is provided in the present disclosure. By the combination of the power source that can discharge at a low temperature and a heating element, the cell phone may be heated when the environmental temperature is too low, so the cell phone may be prevented from becoming dysfunctional because of low temperatures. Moreover, the heating direction of the heating element is defined as an inside direction (toward the cell phone) to prevent undesired heat dissipation. Furthermore, the power source may provide electricity to other devices outside the cell phone heating device to act as a backup power source.

The present disclosure also provides a method for automatically heating the cell phone in cold environments. The cell phone heating device may automatically detect the temperature of the environment and activate automatically when the temperature is lower than a temperature at which the cell phone can operate normally, until the temperature is high enough. As a result, the cell phone may be prevented from being unable to operate normally due to a low environment temperature. Furthermore, the cell phone heating device may automatically stop heating when the temperature has reached the desired temperature to avoid wasting energy.

Although embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope of such processes, machines, manufacture, and compositions of matter, means, methods, or steps. In addition, each claim constitutes a separate embodiment, and the combination of various claims and embodiments are within the scope of the disclosure.

What is claimed is:

1. A cell phone heating device for heating a cell phone, comprising:
a main body;
a heating element disposed in the main body for heating the cell phone;
a temperature-control element disposed in the main body for detecting the temperature of the main body and providing a signal to control the heating element according to the temperature; and
a power source disposed in the main body for providing current to the heating element and the temperature-control element.

2. The cell phone heating device in claim 1, wherein the heating element is a resistive heating element.

3. The cell phone heating device in claim 1, wherein a connecting hole is formed in the main body for connecting other elements.

4. The cell phone heating device in claim 1, further comprising a switch disposed in the main body for activating the heating element to generate heat for a specific amount of time.

5. The cell phone heating device in claim 1, further comprising a plate disposed between the heating element and the power source, wherein the plate is made from heat insulating materials.

6. The cell phone heating device in claim 1, wherein the main body comprises:
a case;
a frame disposed on the case; and
a plate disposed on the case, wherein the heating element, the temperature-control element, and the power source are disposed between the case and the plate.

7. The cell phone heating device in claim 6, wherein the temperature-control element and the heating element does not overlap with each other when viewed in a normal direction of the plate.

8. The cell phone heating device in claim 1, wherein the power source is operable under −20 degree C.
